(19) United States
(12) Patent Application Publication
(10) Pub. No.: US 2010/0129733 A1
(43) Pub. Date: May 27, 2010

(54) INTERCONNECTOR ARRANGEMENT AND METHOD FOR PRODUCING A CONTACT ARRANGEMENT FOR A FUEL CELL STACK

(75) Inventor: Andreas Reinert, Dresden (DE)

Correspondence Address: FITCH, EVEN, TABIN & FLANNERY, P. O. BOX 18415, WASHINGTON, DC, 20036, US

(73) Assignee: Staxera GmbH, Dresden (DE)

(21) Appl. No.: 12/594,445

(22) PCT Filed: Mar. 26, 2008
(86) PCT No.: PCT/DE08/00509

§ 371 Date: Nov. 24, 2009

(30) Foreign Application Priority Data
Apr. 2, 2007 (DE) 10 2007 015 712.8
Apr. 10, 2007 (DE) 10 2007 016 905.3

(51) Int. Cl. H01M 8/02

(52) U.S. Cl. 429/517; 29/623.1

(57) ABSTRACT

The invention relates to an interconnector arrangement for a fuel cell stack, which arrangement can be brought into electrical contact with at least one membrane electrode assembly of the fuel cell stack. The invention is characterized in that the interconnector arrangement comprises a nickel foam which is interposed between at least one housing part of the interconnector arrangement and the membrane electrode assembly to establish an electrically conducting connection. The invention also relates to a method for manufacturing a contact arrangement for a fuel cell stack.

The invention relates to an interconnector arrangement for a fuel cell stack, which can be brought into electrical connection with a least one membrane electrode assembly of the fuel cell stack.

Additionally, the invention relates to a method for manufacturing a contact arrangement for a fuel cell stack.

Conventionally, several individual fuel cells respectively membrane electrode assemblies are combined to a so-called fuel cell rack respectively fuel cell stack to achieve a larger electrical power than an individual fuel cell can provide on its own. In this, adjacent fuel cells of the fuel cell stack are respectively coupled electrically as well as mechanically to each other via connecting interconnector arrangements. Due to this coupling of the individual fuel cells via the interconnector arrangements, there are thus created fuel cells stacked on top of each other and electrically connected in series, which together form the fuel cell stack. Commonly, there are formed gas distributor structures in the interconnector arrangements of prior art, via which supply gases are guided to the respective membrane electrode assembly. These gas distributor structures for example can be formed partly by a housing part of the interconnector arrangement. For this purpose there are provided recesses running like channels respectively bulges in the housing part of the interconnector arrangement, which form a channel wall portion of gas channels. The further channel wall portion then is formed in the mounted state of the interconnector arrangement in the fuel cell stack for example partly by a membrane electrode assembly, in particular by an anode or cathode of an adjacent membrane electrode assembly, such that a gas channel formed from both channel wall portions is created below and above the housing part. Such gas distributor structures of the fuel cell stack are often also called manifolds. These manifolds are used to effect distribution of the supply gases for each membrane electrode assembly into corresponding electrode spaces.

Commonly, the fuel cell stacks are mainly made from ferritic materials. These ferritic materials show a low mechanical stability at high temperatures, which can make itself known in deformations via flowing or creepage. This is the case in particular if a hollow space is formed by a structure pressed from thin-walled sheet metal as is the case in the above-mentioned gas distributor structures having the gas channels. To avoid such deformations, there are often used spacers respectively distance pieces in the corresponding hollow space, which are provided between the housing parts of an interconnector arrangement and a membrane electrode assembly and thus contribute to the stabilization of the fuel cell stack. Embodiments of interconnector arrangements already known are for example provided with frames extending also around the fuel cell stack in its edge region, in particular by annular structures in the region of the manifolds which are at least partly obtained directly from the sheet metal of one or both housing parts of the interconnector arrangement. In a fuel cell stack under tension a force flow is then mainly guided through theses regions, i. e. for example through the annular structure in the edge region. Such force flow guidance respectively force transmission mainly occurring through the frame in the edge region and to a lesser degree through the center region of the manifolds of the fuel cell stack, however, leads to several significant disadvantages. For example, the force flow goes through sealing material, which is arranged in grooves between individual fuel cells and interconnector arrangements, respectively, and in most cases is formed from glass ceramics. Glass ceramics however tends to creepage and flowing, in particular at higher temperatures occurring during operation of the fuel cell stack. With corresponding strain on the seals, the tension of the fuel cell stack is strongly reduced over time due to this creepage behavior. Although the usage of distance pieces leads to a stabilization of the individual interconnector arrangements, the stability of the fuel cell stack as a whole however is still strongly reduced due to the creepage behavior of the seals. To avoid creepage of the seals as far as possible, according to prior art usage of so-called hybrid seals is suggested, which constitute of a mechanically stable ceramics or metal body and glass. Furthermore, at temperatures above 850° C., as they appear in particular in connection with operation of SOFC fuel cell stacks, there are little possibilities for using elastic parts. Therefore the seals at the edge region of the fuel cell stack and the electrical contacting of the fuel cell stack (active area) arranged further to the interior are always in competition with the seals at the edge via the interconnector arrangement. As it is difficult to form an adhesive bond between a cathode of a membrane electrode assembly and a housing part, in particular a sheet metal part, of the interconnector arrangement, there is a dependency of the force flow acting in the active area. In the case of a fuel cell supported in the edge region and in the manifold by the use of massive materials, for example by distance pieces or spacers, creepage of the materials in the active region of the fuel cell stack can lead to loss of the electrical contact between the fuel cells and thus to degradation of the total system.

The invention is based on the objective to further develop the generic interconnector arrangements and methods for manufacturing of components of interconnector arrangements such that a contacting of individual fuel cells of a fuel cell stack can be ensured also at high operation temperatures.

This objective is achieved by the features of the independent claims.

Further advantageous embodiments of the inventions are obtained by the dependent claims.

The inventive interconnector arrangement adds to the generic prior art in that the interconnector arrangement comprises a nickel foam interposed between at least one housing part of the interconnector arrangement and the membrane electrode assembly to establish an electrically conducting connection. The nickel foam preferably is in contact with an anode of the membrane electrode assembly. With this there is obtained a homogeneous nickel surface on the side of the interconnector arrangement facing the anode, which can ideally bond to the nickel of the anode.

The inventive interconnector arrangement advantageously can be further developed in that a massive ferritic chrome steel or a massive ferritic steel, which are also used for further components of the fuel cell stack, is embedded in the nickel foam. Due to the usage of a thus stabilized nickel foam the force flow through the active region of the fuel cell stack can be guided even more effectively. As materials for this embedding in the nickel foam any materials can be considered which can be used in the context of stabilizing the fuel cell stack, as long as these materials have the required electrical, thermic, mechanical and chemical characteristics. In this there are preferred in particular such substances respectively materials which are also used for the common components of the fuel cell stack, in particular for the interconnector cassettes.

Furthermore, the interconnector arrangement can be formed such that the ferritic chrome steel or the ferritic steel is embedded in the nickel foam in form of at least one wire or a one sheet metal strip. This enables guiding the force flow created by tensioning of the fuel cell stack through massive materials, like the membrane electrode assembly (MEA), the strongly compressed nickel foam, the at least one wire or sheet metal strip embedded in the nickel foam, contact bars etc. The force flow thus is guided to a larger degree through the active region of the fuel cell stack. Stabilization of the nickel foam preferably is achieved through embedding massive materials like the ferritic chrome steel wire or the ferritic chrome steel sheet metal strip by for example rolling the wire into the nickel foam.

Moreover, the inventive interconnector arrangement can be realized such that the wire is rolled and arranged in the nickel foam such that surface portions of the wire rolled flat are in contact with the housing part and the membrane electrode assembly, respectively. Thus beneficially there is no line contact present between the housing part of the interconnector arrangement and the membrane electrode assembly, as the wire is rolled flat at least in portions directly in the force flow. Therefore, there are created for example two plane contact surfaces respectively surface portions of the wire facing each other for the housing part of the interconnector arrangement and the membrane electrode assembly through which the force flow can run.

The inventive repetition unit comprises the inventive interconnector arrangement and a membrane electrode assembly being in electrically conducting connection with the inventive interconnector arrangement.

The inventive fuel cell stack comprises a plurality of the inventive repetition units.

In the inventive method for manufacturing a contact arrangement for fuel cell stack having a stabilized nickel foam serving in particular for reception between a housing part of the inventive interconnector arrangement and a membrane electrode assembly, initially a nickel foam string is manufactured. Subsequently, a ferritic chrome steel or a ferritic steel, which are also used for further components of the fuel cell stack, is rolled into the nickel foam in the form of at least one wire or one sheet metal strip. In this there are obtained the advantages explained in the context of the inventive interconnector arrangement in a similar or equal way, for which reason it is referred to the advantages described in the context of the inventive interconnector arrangement to avoid repetitions.

The inventive method can be further developed advantageously by cutting the stabilized nickel foam with the at least one wire or sheet metal strip embedded therein into string portions.

In the following there is explained by way of example a preferred embodiment of the invention by means of the figures.

These show:

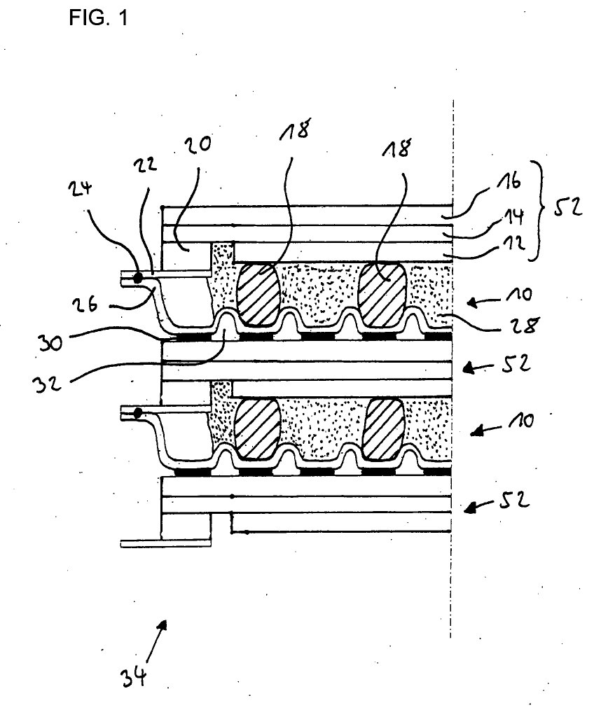

FIG. 1 a depiction of an inventive interconnector arrangement in the fuel cell stack and

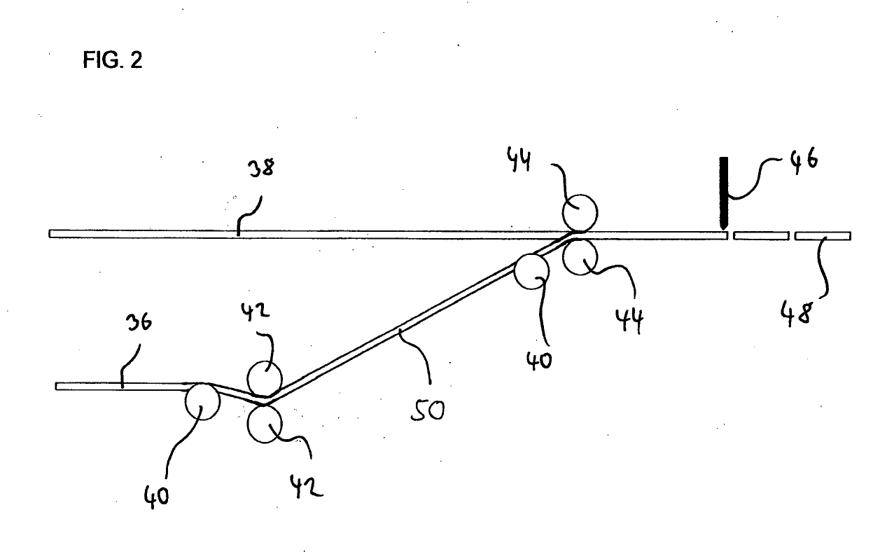

FIG. 2 a depiction of a manufacturing route adapted for performing the inventive method for manufacturing a stabilized nickel foam.

FIG. 1 shows a depiction of an inventive interconnector arrangement 10 in a fuel cell stack 34. To simplify the following explanations there are only shown three membrane electrode assemblies 52 and two interconnector arrangements. The fuel cell stack 34 however can comprise any number of membrane electrode assemblies 52 with interconnector arrangements 10 connecting them. In the depicted case the inventive interconnector arrangement 10 is arranged between two membrane electrode assemblies 52 which comprise at least an anode 12, an electrolyte 14 as well as a cathode 16, respectively. In this each membrane electrode assembly 52 and an interconnector arrangement 10 in contact with the anode 12 of the membrane electrode assembly 52 form a repetition unit of the fuel cell stack.

The interconnector arrangement 10 comprises an upper housing part 22 and a lower housing part 26. The upper housing part 22 is coupled to the electrolyte 14 of the membrane electrode assembly 52 arranged above an interconnector arrangement 10 via a glass ceramics seal 20. The lower housing part 26 on the other hand is coupled to the cathode 16 of a membrane electrode assembly 52 arranged below this interconnector arrangement 10 via several contact bars 30. In this there can be provided any number of contact bars 30. The lower housing part 26, the upper housing part 22 and the anode 12 form an intermediate space, in which a nickel foam 28 with wires 18 enbedded therein is received. The wires are in particular ferritic chrome steel wires. In this, each wire 18 is received in a bulge of the lower housing part 26 and respectively is in contact with its bulge base. In addition, the wire 18 is in contact with the anode 12 of the upper membrane electrode assembly 52. There can be arranged any number of wires 18 in the bulges corresponding to the number of bulges in the lower housing part 26. At a bottom side of the lower housing part 26, i. e. between the lower housing part 26 and the lower membrane electrode assembly 52, there are respectively formed gas channels 32 by means of the bulges formed in the lower housing part 26, the contact bars 30 and the lower membrane electrode assembly 52. Preferably in this case a gas with high oxygen content or pure oxygen is guided through the gas channels 32, wherein on the other hand a gas with rich hydrogen content or pure hydrogen is guided through the nickel foam 28. In this each wire 18 is rolled such that just surface portions of the wire 18 which are rolled flat are in contact with the anode 12 of the upper membrane electrode assembly 52 and the lower housing part 26, in particular with the base of the bulges of the lower housing part 26. In this case the upper housing part 22 and the lower housing part 26 are connected to each other via a welding seam 24.

FIG. 2 shows a depiction of a manufacturing route adapted for performing the inventive method for manufacturing a stabilized nickel foam. Initially, one or more wire strings 36 are guided parallel to each other via a guiding roller 40 provided with grooves of the manufacturing route. In this the distance of the wire strings 36 running parallel to each other can be set using the grooves in the guiding roller 40. After running through the guiding roller 40, the wire strings 36 are subjected to a rolling process on their top and lower sides using wire rolling 42. Thereby there is obtained a rolled wire string 50 which is rolled flat at least on its top and bottom side. Subsequently, the wire strings 50 arrive between two nickel foam rollers 44 of the manufacturing route via a further guiding roller 40 of the manufacturing route. In this location, a nickel foam string 38 having a width at least corresponding to the number of rolled wire strings 50 arranged parallel to each other is simultaneously guided between the nickel foam rollers 44. After running through the nickel foam rollers 44, the wire strings 50 are embedded in the nickel foam string 38 due to the rolling via the nickel foam rollers 44. Thus the stabilized nickel foam string is formed. Subsequently, the stabilized nickel foam string having the rolled wire strings 50 embedded therein is subjected to a cutting process using a cutting device 56, such that individual nickel foam string portions 48 are formed which are adapted to, respectively constructed for, the interconnector arrangement 10.

The features of the invention disclosed in the above specification, in the figures as well as the claims can be essential for the implementation of the invention individually as well as in any combination.

### LIST OF REFERENCE NUMERALS

12 anode of the membrane electrode assembly
14 electrolyte of the membrane electrode assembly
16 cathode of the membrane electrode assembly
18 wire
20 glass ceramics seal
22 upper housing part
24 welding seam
26 lower housing part
28 nickel foam
30 contact bar
32 gas channel
34 fuel cell stack
36 wire string
38 nickel foam string
40 guiding roller
42 wire rollers
42 nickel foam rollers
44 cutting device
46 stabilized nickel foam string portion
48 rolled wire string
52 membrane electrode assembly

1. An interconnector arrangement for a fuel cell stack, which can be brought into electrical connection with at least one membrane electrode assembly of the fuel cell stack, characterized in that the interconnector arrangement comprises a nickel foam, which is interposed between at least one housing part of the interconnector arrangement and the membrane electrode assembly for establishing an electrically conducting connection.

2. The interconnector arrangement of claim 1, characterized in that a massive ferritic chrome steel or a massive ferritic steel, which are also used for further components of the fuel cell stack, is embedded in the nickel foam.

3. The interconnector arrangement of claim 2, characterized in that the ferritic chrome steel or the ferritic steel is embedded in the nickel foam in form of a least one wire or one sheet metal strip.

4. The interconnector arrangement of claim 3, characterized in that the wire is rolled and arranged in the nickel foam such that surface portions of the wire which are rolled flat are in contact with the housing part and the membrane electrode assembly, respectively.

5. A repetition unit having an interconnector arrangement claim 1 and a membrane electrode assembly in electrically conducting connection with the interconnector arrangement.

6. A fuel cell stack having a plurality of repetition units of claim 5.

7. A method for manufacturing a contact arrangement for a fuel cell stack comprising a stabilized nickel foam, which serves in particular for reception between a housing part of an interconnector arrangement and a membrane electrode assembly, the method comprising the following steps:
manufacturing a nickel foam string and
rolling into the nickel foam a ferritic chrome steel or a ferritic steel, which are also used for further components of the fuel cell stack, in form of at least one wire or one sheet metal strip.

8. The method of claim 7, characterized by cutting into string portions the stabilized nickel foam having embedded therein the at least one wire or sheet metal strip.
